(19) United States
(12) Patent Application Publication
(10) Pub. No.: US 2022/0081935 A1
(43) Pub. Date: Mar. 17, 2022

(54) LOCKING DEVICES AND RELATED METHODS OF INSTALLATION

(71) Applicant: 3M INNOVATIVE PROPERTIES COMPANY, St. Paul, MN (US)

(72) Inventor: Craig D. Thompson, Inver Grove Heights, MN (US)

(21) Appl. No.: 17/413,981

(22) PCT Filed: Dec. 30, 2019
(86) PCT No.: PCT/IB2019/061445

§ 371 Date: Jun. 15, 2021

Related U.S. Application Data
(60) Provisional application No. 62/786,585, filed on Dec. 31, 2018.

(51) Int. Cl. E05B 47/00; E05B 65/00; E05B 65/44; E05B 65/46

(52) U.S. Cl. CPC E05B 47/004; E05B 65/46; E05B 65/44; E05B 65/0014

(57) ABSTRACT

Disclosed is a locking device for an enclosure, such as a cabinet. The locking device includes a catch attached to the frame. The catch has a first portion provided adjacent to a surface of the frame, and a second portion extending from and generally perpendicular to the first portion. The second portion is provided adjacent to an end of the frame. The locking device further includes a latch attached to the movable component. The latch includes a locking arm having a projection adapted to engage with the second portion of the catch upon movement of the movable component away from the first portion of the catch. Such a shape of the catch may prevent failure of the attachment between the catch and the frame.

### TECHNICAL FIELD

The present disclosure relates generally to locking devices, and more specifically to a locking device and a method of installing the locking device.

### BACKGROUND

Locking arrangements for preventing young children to open or gain access to a cabinet or a drawer are known. Such arrangements generally prevent the cabinet or the drawer to be opened through typical pull forces which may be applied by young children.

Such childproof locking arrangements are typically prone to failure due to detachment of the adhesive between the catch and the frame. A relatively small area of the adhesive may receive almost the entire pull force resulting in high shear stresses on the adhesive. In some cases, the shear stresses may be quite high leading to failure of the adhesive connection. For example, a maximum pull force for a three-year-old male child is about 45 pounds which may be enough to cause failure in such circumstances. Therefore, an improved childproof locking arrangement is required.

In one aspect, the present disclosure provides a locking device for an enclosure. The enclosure has a frame and a movable component. The locking device includes a catch attached to the frame. The catch includes a first portion provided adjacent to a surface of the frame. The catch includes a second portion extending from and generally perpendicular to the first portion. The second portion is located adjacent to an end of the frame. The locking device includes a latch attached to the movable component. The latch includes a locking arm. The locking arm includes a projection which engages with the second portion of the catch upon movement of the movable component away from the first portion of the catch.

In another aspect, the present disclosure provides a method of installing a locking device on an enclosure. The enclosure has a frame and a movable component. The method includes attaching a catch of the locking device to the frame such that a first portion of the catch is provided adjacent to an inner surface of the frame and a second portion of the catch is provided adjacent to an end of the frame. The second portion extends from and is generally perpendicular to the first portion. The method further includes attaching a latch of the locking device to the movable component. The latch includes a locking arm having a projection which engages with the second portion of the catch upon movement of the movable component away from the first portion of the catch.

In another aspect, the present disclosure provides a locking device for an enclosure. The enclosure has a frame and a movable component. The locking device includes a catch having a first portion, and a second portion. The second portion extends from and is generally perpendicular to the first portion. The locking device includes a catch adhesive construction for attaching the first portion of the catch to a surface of the frame such that the second portion of the catch is provided adjacent to an end of the frame. The locking device includes a latch attached to the movable component. The latch includes a locking arm. The locking arm includes a projection which engages with the second portion of the catch upon movement of the movable component away from the first portion of the catch. The locking device further includes a bridge removably coupled to both the catch and the latch. The bridge is coupled to the catch and the latch during attachment of the catch to the frame and attachment of the latch to the movable component. Further, the bridge is removed from the catch and the latch after attachment of the catch to the frame and attachment of the latch to the movable component.

As recited herein, all numbers should be considered modified by the term “about”. As used herein, “a”, “an”, “the”, “at least one”, and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a front perspective view of a magnetic type locking device;

FIG. 2 is an exploded view of the locking device of FIG. 1;

FIG. 3 is an exploded view of a latch of the locking device of FIG. 1;

FIG. 4 is a side view of the locking device of FIG. 1 coupled with an enclosure;

FIG. 5 is a side sectional view of the locking device of FIG. 4;

FIG. 6 is a side sectional view of a catch attached to a frame showing a first configuration of a catch recess;

FIG. 7 is a side sectional view of a catch attached to a frame showing a second configuration of a catch recess;

FIG. 8 is a perspective view of a catch for use with frameless enclosures;

FIG. 9 is a side sectional view of the locking device having a bridge disposed between the catch and the latch showing a locking arm in a disengaged position;

FIG. 10 is a side sectional view of the locking device of FIG. 9;

FIG. 11 is an exploded view of a magnetic key;

FIG. 12 is a perspective view of a magnetic type locking device for installation in a cabinet;

FIG. 13 is a front perspective view of a spring type locking device;

FIG. 14 is an exploded view of the locking device of FIG. 12;

FIG. 15 is an exploded view of a latch of the locking device of FIG. 12;

FIG. 16 is a side sectional view of the locking device of FIG. 12;

FIG. 17 is a perspective view of a spring type locking device for installation in a cabinet;

FIG. 18A-F show a first set of exemplary steps for installation of the locking device;

FIG. 19A-F show a second set of exemplary steps for installation of the locking device;

FIG. 20A-F show a third set of exemplary steps for installation of the locking device;

FIG. 21A-F show a fourth set of exemplary steps for installation of the locking device; and

FIG. 22 is a side sectional view of another locking device coupled with a frame.

Layers in certain depicted embodiments are for illustrative purposes only and are not intended to absolutely define the thickness, relative or otherwise, or the absolute location of any component. While the above-identified figures set forth several embodiments of the disclosure other embodiments are also contemplated, as noted in the description. In all cases, this disclosure is presented by way of representation and not limitation. It should be understood that numerous other modifications and embodiments can be devised by those skilled in the art, which fall within the scope and spirit of the principles of the disclosure.

### DETAILED DESCRIPTION

Various embodiments and implementations will be described in detail. These embodiments should not be construed as limiting to the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

The locking devices of present disclosure provide reliable childproofing for various enclosures, such as drawers and cabinets. The locking devices are not only easy to use, but also offer convenience of installation and removal. The locking devices can include a generally L-shaped catch that contacts a surface of a frame of an enclosure. The L-shaped catch reduces a pull force applied on a connection (for example, an adhesive connection) between the catch and the frame. This may prevent the failure of the connection due to the application of typical pull forces leading to improved reliability of the locking devices. The locking devices further include a bridge that acts as an alignment feature during installation. The bridge remains attached to the catch and a corresponding latch during installation to enable alignment between the catch and the latch. In some cases, the bridge disengages a lock (for example, a magnetic lock) which makes installation easier.

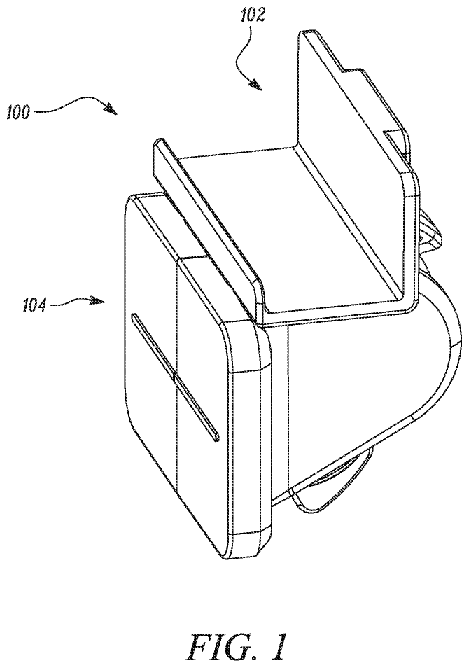

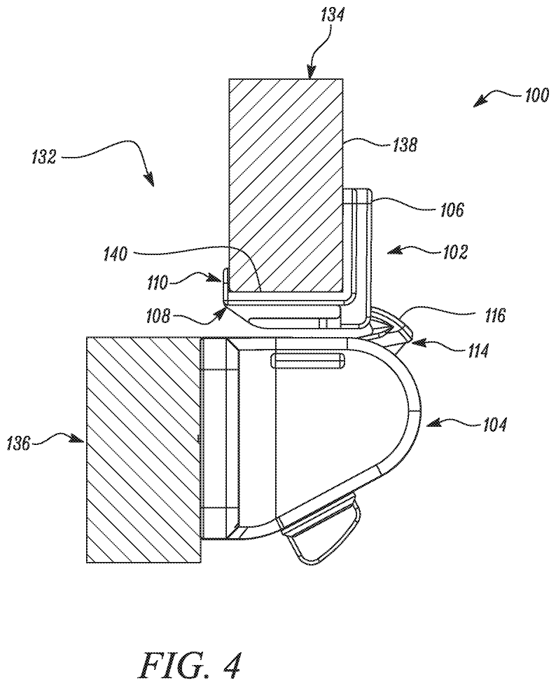

FIG. 1 illustrates a locking device 100 according to one embodiment of the present disclosure. The locking device 100 may be used for locking an enclosure (shown in FIG. 4). In some cases, the enclosure may be a cabinet or a drawer. The locking device 100 is a magnetic locking device. The locking device 100 includes a catch 102 and a latch 104.

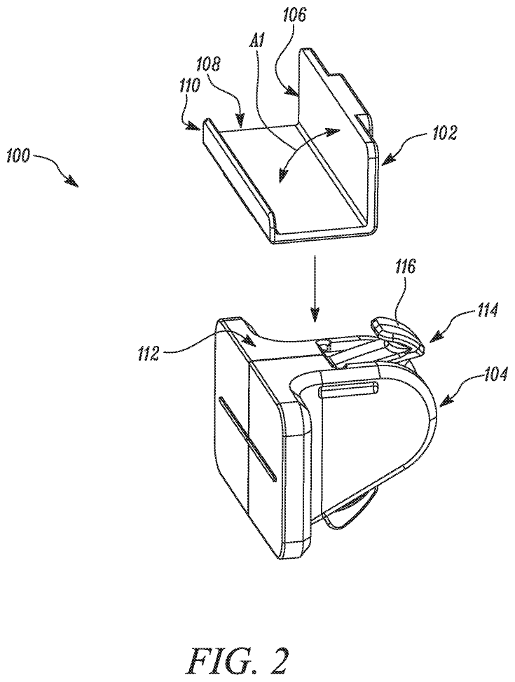

FIG. 2 shows an exploded view of the locking device 100. The catch 102 has a first portion 106 and a second portion 108. The second portion 108 extends from the first portion 106. Further, the second portion 108 is generally perpendicular to the first portion 106. An angle “A1” is defined between the first portion 106 and the second portion 108. The angle “A1” may be substantially equal to 90 degrees with some amount of variation, for example, less than 5% or less than 10%. In some cases, the angle “A1” may be between about 85 degrees and about 95 degrees. In some other cases, the angle “A1” may be between about 80 degrees and about 100 degrees. The catch 102 may therefore be generally L-shaped.

The catch 102 further includes a lip 110 extending from the second portion 108. The lip 110 extends generally perpendicular to the second portion 108. The lip 110 may improve the alignment between the components on assembly and enable improved retention of the catch 102 on a frame of the enclosure with which the locking device 100 is attached. The lip 110 may prevent axial motion of the catch 102 relative to the frame of the enclosure.

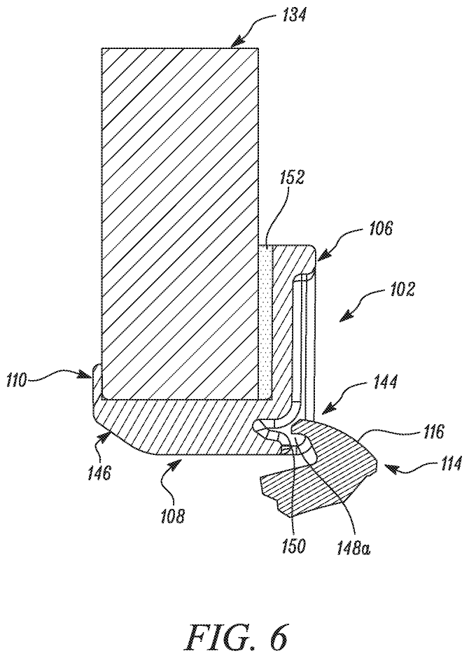

The latch 104 includes a latch housing 112. The latch 104 further includes a locking arm 114 extending from the latch housing 112 for locking the latch 104 with the catch 102. The locking arm 114 includes a projection 116. The projection 116 engages with the second portion 108 of the catch 102. In the illustrated embodiment, the projection 116 of the locking arm 114 is a hook that is adapted to engage with a catch recess (shown in FIGS. 6-8). In an alternative example, the catch 102 may include a hook (not shown) and the locking arm 114 may have a recess (not shown) which engages with the hook of the catch 102. Other variations of the structural configurations of the locking arm 114 and the catch 102 may also be envisioned within the scope of the present disclosure.

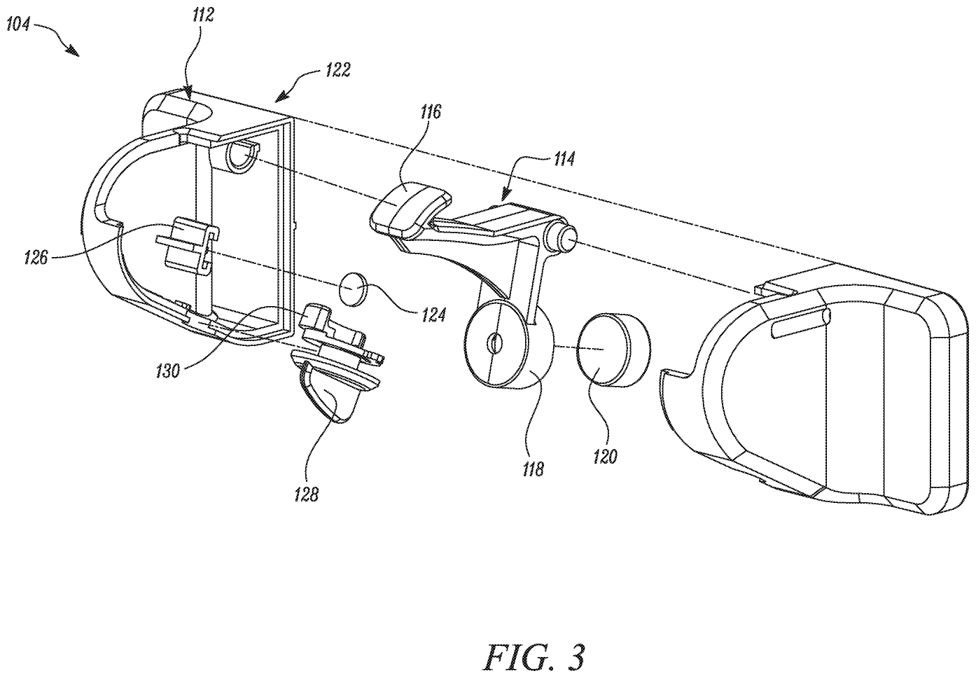

FIG. 3 shows an exploded view of the latch 104. The latch housing 112 at least partially encloses the locking arm 114. The locking arm 114 has a magnet housing 118 coupled to the locking arm 114, with the housing 118 adapted to receive and contain a first magnet 120. The latch housing 112 further includes a second magnet 124 disposed within a holder 126 within the latch housing 112. Although, the first and second magnets 120, 124 are illustrated as disc shaped magnets, the present disclosure is not limited by shape and size of the magnets in any manner. Each of the first and second magnets 120, 124 have two opposing surfaces of opposite polarities. The latch 104 further includes a rotatable switch 128 for actuating the locking arm 114. The latch housing 112 further includes a cam member 130 operatively coupled with the rotatable switch 128.

FIG. 4 shows a side view of the locking device 100 attached to an enclosure 132. The enclosure 132 has a frame 134 and a movable component 136. In some cases, the enclosure 132 may be a cabinet or a drawer. The movable component 136 may be a door of a cabinet or a drawer. In some cases, the enclosure 132 is a framed cabinet where the movable component 136 is connected to a separate frame which is connected to a structure of the enclosure 132. In such cases, the frame 134 may be part of the separate frame. In some other cases, the enclosure 132 is a frameless cabinet where the movable component 136 is connected to the structure of the enclosure 132. In such cases, the frame 134 is not a separate frame, but part of the structure of the enclosure 132. The movable component 136 may move away from the frame 134 for opening the enclosure 132 and the movable component 136 may move towards the frame 134 for closing the enclosure 132. Although, the examples provided are typically envisioned as cuboidal shapes, it should be contemplated that the enclosure 132 may be of any suitable shape which may be applicable with various aspects of the present disclosure. The locking device 100 may prevent a young child to open the enclosure 132 or gain access to the enclosure 132. The young child may be a toddler or a child below five years of age. In some cases, the young child may be below three years of age.

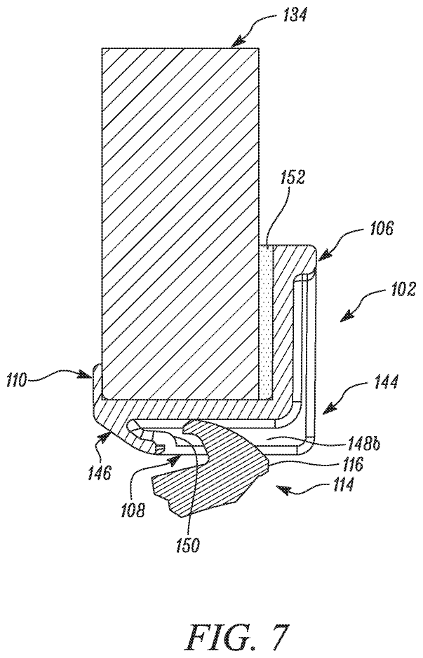

The catch 102 is attached to the frame 134. The first portion 106 of the catch 102 is disposed adjacent to a surface 138 of the frame 134. The second portion 108 of the catch 102 is disposed adjacent to an end 140 of the frame 134. The latch 104 is coupled to the movable component 136. When the movable component 136 moves away from the frame 134, the projection 116 engages with the second portion 108 of the catch 102. More specifically, when the movable component 136 moves away from the second portion 108 of the catch 102, the projection 116 engages with the second portion 108 of the catch 102. The second portion 108 of the catch 102 further includes a catch recess (shown in FIGS. 6 and 7) that is adapted to releasably engage with the projection 116 of the latch 104. More specifically, the projection 116 engages with the catch recess upon movement of the movable component 136 away from the frame 134.

As illustrated, the locking device 100 provides an improved substantially L-shaped design of the catch 102. When a pulling force is applied on the movable component 136 by the user, the latch 104 imparts a force on the catch 102 and most of the force is absorbed by the first portion 106 of the catch 102.

It should be noted that each of the first and second portions 106, 108 of the catch 102 has a generally cuboidal shape. Further, the catch recess may be located between edges of the second portion 108. The catch 102 may be made of any suitable material, for example, metals or metallic alloys, plastics, composites, and so forth.

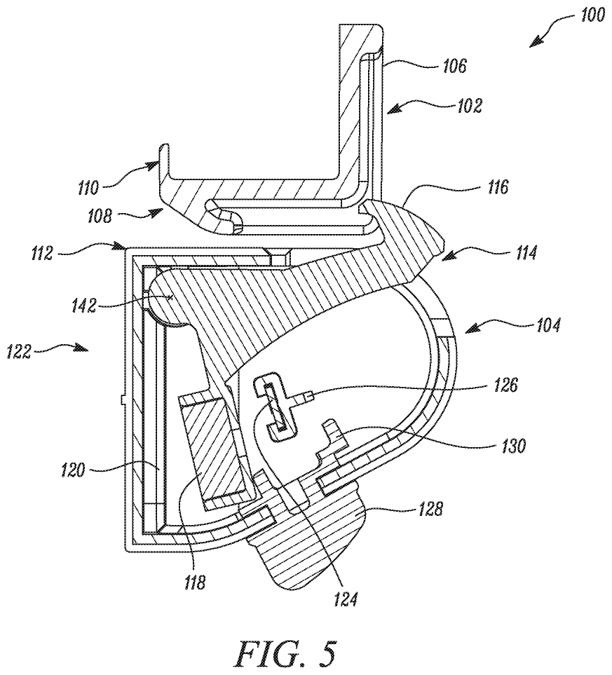

FIG. 5 shows a side cross-sectional view of the locking device 100 as shown in FIG. 4. The first magnet 120 and the second magnet 124 are placed such that surfaces of opposite polarities face each other. For example, the first magnet 120 may have a north pole side facing towards the second magnet 124 and the second magnet 124 may have a south pole side facing towards the first magnet 118. It should be contemplated that alternative polarity arrangements may also be envisioned well within the scope of the present disclosure.

The rotatable switch 128 may move between an engaged configuration and a disengaged configuration. In the engaged configuration, the rotatable switch 128 allows the locking arm 114 to be engaged with the catch 102, and in the disengaged configuration, the rotatable switch 128 does not allow the locking arm 114 to be engaged with the catch 102. The rotatable switch 128 is illustrated in the engaged configuration in FIG. 5. While the rotatable switch 128 is in the engaged configuration, the second magnet 124 attracts the first magnet 120 towards the holder 126 without physical interference, causing the locking arm 114 to pivot about a pivot axis 142 and moving the projection 116 towards from the catch 102. Thus, and for so long as the attraction is maintained, the projection 116 engages the catch 102.

Rotation of the rotatable switch 128 from the engaged configuration to a disengage configuration may cause the cam member 130 to rotate and be located between the locking arm 114 and the holder 126. The cam member 130 moves the holder 126 away from the first magnet 120. Rotation causes the cam member 130 to drive the first magnet 120 towards the front side 122 of the latch housing 112 away from the second magnet 124. This causes the locking arm 114 to pivot about the pivot axis 142 near top of the latch housing 112 and move the projection 116 away from the catch 102. This overcomes the attraction between magnets 120, 124 and allows the projection 116 to be disengaged from the catch 102.

FIGS. 6 and 7 illustrate different embodiments of the catch 102 showing various structural configurations of the catch recess. With reference to FIG. 6, the second portion 108 of the catch 102 further comprises a proximal end 144 and a distal end 146. The proximal end 144 is located adjacent to the first portion 106 of the catch 102. The distal end 146 is located opposite to the proximal end 144. In the illustrated embodiment, the proximal end 144 has a chamfered shape. Further, the distal end 146 has vertical part and an inclined part. However, the proximal and distal ends 144, 146 may have alternative shapes within the scope of the disclosure. A catch recess 148a is defined such that the catch recess 148a terminates proximate the proximal end 144. Specifically, the catch recess 148a terminates at a recess end 150a disposed proximate the proximal end 144. The projection 116 of the locking arm 114 engages with the catch recess 148a proximate the proximal end 144. The recess end 150a is a generally V-shaped notch that engages with the projection 116 of the latch 104.

Another exemplary configuration is illustrated in FIG. 7. A catch recess 148b terminates proximate the distal end 146 of the second portion 108 of the catch 102. Specifically, the catch recess 148b terminates at a recess end 150b disposed proximate the distal end 146. The projection 116 of the locking arm 114 engages with the catch recess 148b at the distal end 146. The recess end 150b is a generally V-shaped notch that engages with the projection 116 of the latch 104.

Another exemplary embodiment may be envisioned for the catch recess 148 in which the catch recess 148 may terminate generally midway between the proximal end 144 and the distal end 146. The present disclosure is not limited by the position of termination of the catch recess 148 in any manner. Further, in an embodiment, the catch 102 may be envisioned without the lip 110.

It should be contemplated that the parts and components shown in FIGS. 6 and 7 apart from the catch 102, 102a and catch recess 148a, 148b are substantially the same, and therefore have been referred with same reference numbers. With combined reference to FIGS. 6 and 7, the locking device 100 further includes a catch adhesive construction 152 adapted to attach the catch 102 to the frame 134. As illustrated in FIGS. 6 and 7, the catch adhesive construction 152 is disposed between the second portion 108 of the catch 102 and the frame 134. The catch adhesive construction 152 may be a Command® Adhesive Strip, available from 3M Company, St. Paul, Minn. Command® Adhesive Strip products are a line of stretch removable adhesive strips that hold strongly on a variety of surfaces (including paint, wood, and tile) and that remove cleanly, i.e., without any holes, marks, or sticky residue. These products generally have utility in bonding to various surfaces or substrates for numerous applications.

In general, these products include a stretch release adhesive composition disposed on tape or other backings. Stretch releasable adhesives are high performance pressure-sensitive adhesives that combine strong holding power with clean removal and no surface damage. Stretch releasable adhesive products are designed to firmly adhere an article, such as the locking device 100, to a surface (an adherend, such as a door, a frame, a drawer etc.), yet remove cleanly when pulled away from the architectural surface at a low angle. The clean removal aspect means that a tacky and/or unsightly residue is not left behind on the surface after removal of the stretch release adhesive and that no damage to the surface occurs during the removal process. During the process of stretch release removal, the adhesive layer typically remains adhered to the tape backing as the backing is stretched, but releases from the surface (adherend).

Although, the present disclosure depicts the catch adhesive construction 152 as stretch-releasable Command® strips, however, the catch adhesive construction 152 may be any other suitable adhesive construction. In some cases, the catch adhesive construction 152 includes an adhesive foam. The catch adhesive construction 152 is disposed between the second portion 108 of the catch 102 and the frame 134. The catch adhesive construction 152 may alternatively or additionally be disposed between the first portion 106 of the catch 102 and the frame 134. By placing the catch adhesive construction 152 between the first portion 106 of the catch 102 and the frame 134, reaction force on the catch adhesive construction 152 is mostly compressive with reduced shear stress on the catch adhesive construction 152 as compared to conventional designs. This may result in a higher pull force capability of the locking device 100.

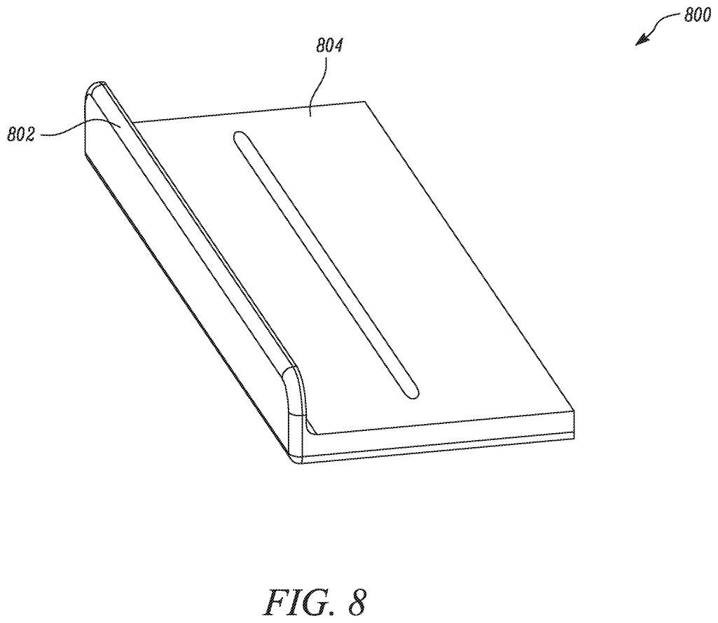

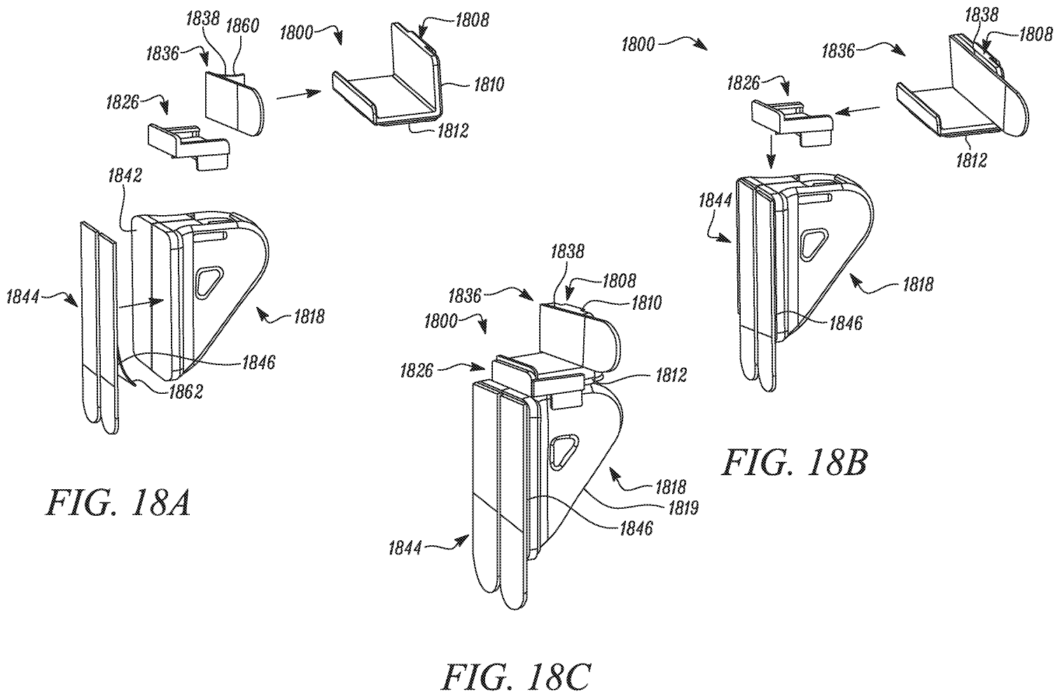

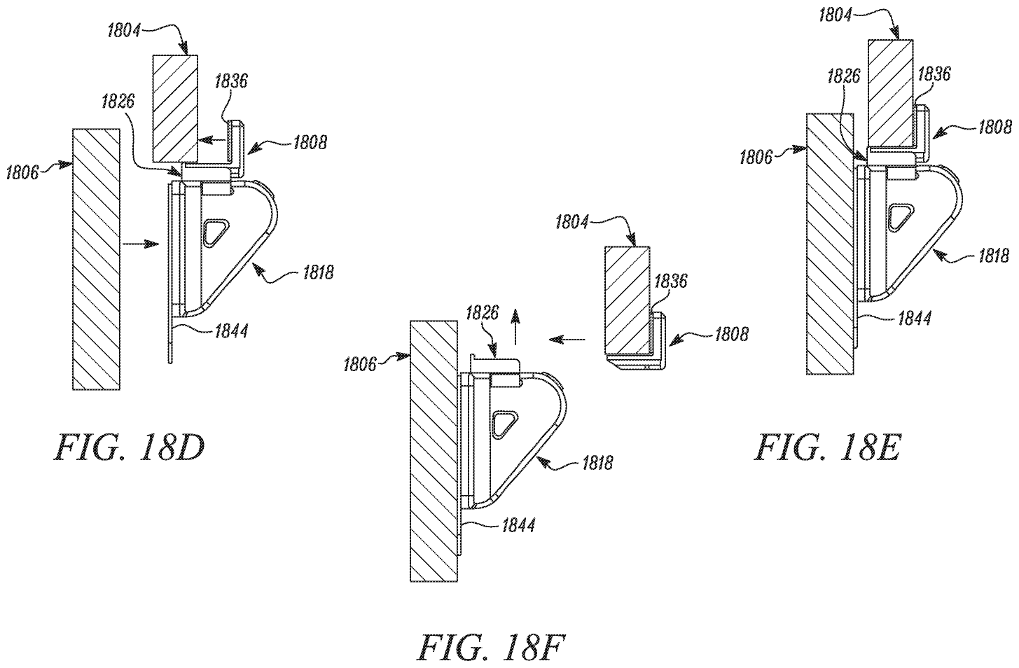

FIG. 8 shows another embodiment of a catch 800 adapted to be used with a frameless cabinet (not shown). The catch 800 includes a first portion 802 and a second portion 804. The first portion 802 is a lip-type structure which may help with better retention with the frameless cabinet. The second portion 804 extends from and is substantially perpendicular to the first portion 802. It should be contemplated that the installation steps described in FIGS. 18A-21F may also be applied to a locking device including the catch 800 by appropriately modifying the steps to suit the structural configuration of the catch 800. For example, a catch adhesive construction (not shown) may be attached to the second portion 804 to couple the catch 800 with the frameless cabinet.

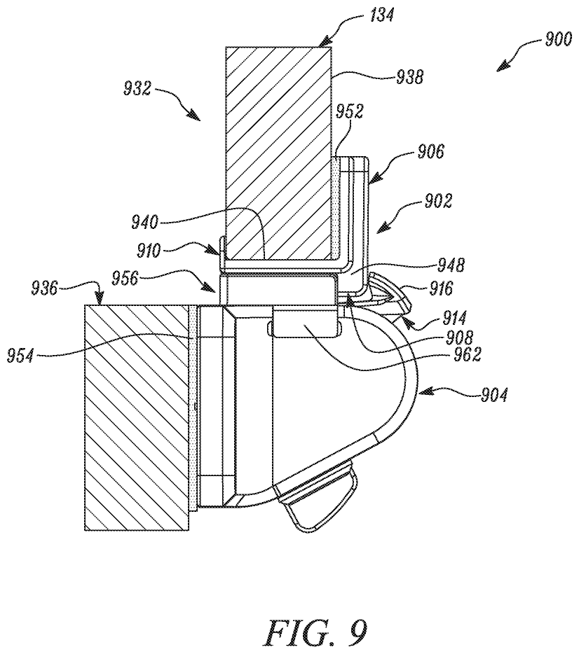

Referring to FIG. 9, another configuration for a locking device 900 for an enclosure 932 is provided. The locking device 900 includes a catch 902 attached to a frame 934. The catch 902 has a first portion 906 and a second portion 908. The first portion 906 is provided adjacent to a surface 938 of the frame 934. The second portion 908 is provided adjacent to an end 940 of the frame 934. The second portion 908 extends from the first portion 906. Further, the second portion 908 is generally perpendicular to the first portion 906.

The catch 902 further includes a lip 910 extending from the second portion 908. The lip 910 extends generally perpendicular to the second portion 908. The lip 910 may improve the alignment between the components on assembly and enable improved retention of the catch 902 on the frame 934 of the enclosure 932 with which the locking device 900 is attached. The lip 910 may prevent axial motion of the catch 902 relative to the frame 934 of the enclosure 932.

The locking device 900 includes a latch 904 coupled to a movable component 936. The latch 904 has a locking arm 914 for locking the latch 904 with the catch 902, and in turn locking the movable component 936 with the frame 934. The locking arm 914 has a projection 916. When the movable component 936 moves away from the frame 934, the projection 916 engages with the second portion 908 of the catch 902. More specifically, when the movable component 936 moves away from the second portion 908 of the catch 902, the projection 916 engages with the second portion 908 of the catch 902. More specifically, the projection 916 engages with a catch recess 948 defined by the second portion 908 of the catch 902. In an example, the projection 916 of the locking arm 914 is a hook that is adapted to engage with the catch recess 948.

The locking arm 914 of the latch 904 may be pivoted between an engaged position and a disengaged position, typically by application of a magnetic field provided by an external magnet. The locking device 900 prevents the opening of the enclosure 932 when the locking arm 914 is in the engaged position.

Further, the locking device 900 allows opening of the enclosure 932 when the locking arm 914 is in the disengaged position relative to the catch 902. The locking arm 914 is depicted in the disengaged position in FIG. 9. The locking arm 114 is depicted in the engaged position in FIGS. 4 and 5.

The locking device 900 includes a catch adhesive construction 952 between the frame 934 and the first portion 906 of the catch 902. Also, the locking device 900 includes a latch adhesive construction 954 between the latch 904 and the movable component 936. The catch adhesive construction 952 and the latch adhesive construction 954 may be Command® adhesive strips.

The locking device 900 further includes a bridge 956 adapted to be removably coupled to both the catch 902 and the latch 904. The bridge 956 may have any suitable shape such that the bridge 956 can be detachably attached to both the catch 902 and the latch 904. The bridge 956 allows easier installation of the locking device 900. The bridge 956 is coupled to the catch 902 and the latch 904 during attachment of the catch 902 to the frame 934 and attachment of the latch 904 to the movable component 936. The bridge 956 is removed from the catch 902 and the latch 904 after attachment of the catch 902 to the frame 934 and attachment of the latch 904 to the movable component 936. The bridge 956 acts as an intermediate component to temporarily hold the catch 902 and the latch 904 together during installation of the locking device 900. Specifically, the bridge 956 enables alignment between the catch 902 and the latch 904 during installation. Such alignment may be required to ensure that the projection 916 engages with the catch recess 948 upon movement of the movable component 936 away from the frame 934, or the first portion 906 of the catch 902 after the locking device 900 is installed. (as shown below in FIG. 18).

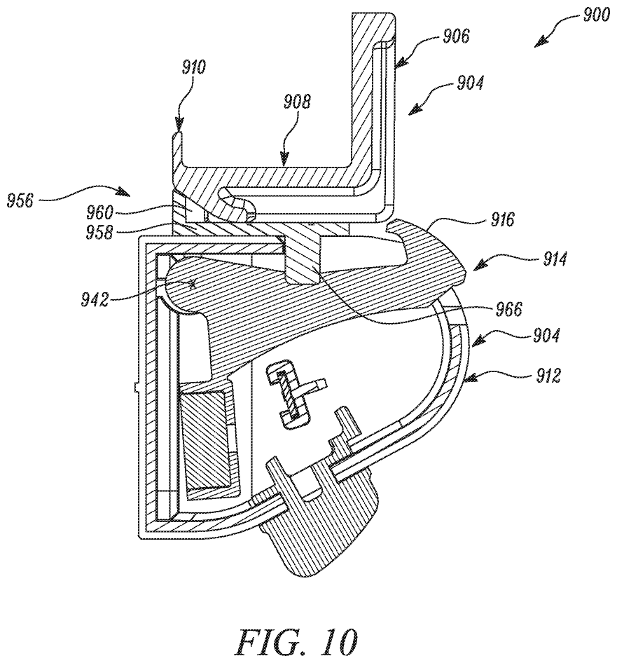

FIG. 10 shows a sectional view of the locking device 900. The bridge 956 has a first bridge portion 958 which is detachably attached to the latch 904. The first bridge portion 958 may be slidably attached to the latch 904. The first bridge portion 958 may also be attached to the latch 904 through any other suitable removable coupling methods, such as snap-fit, hook and loop fastener, etc. The first bridge portion 958 may be shaped such as to conform to the shape of the latch 904. The bridge 956 may be coupled with the latch 904 through a snap-fit arrangement. The first bridge portion 958 and/or the latch 904 may define tabs or projections on outer surfaces which allows the bridge 956 and the latch 904 to be snap fitted with each other. In the illustrated embodiment, the bridge 956 includes a pair of tabs 962 (shown in FIG. 9) which extend downwards from the bridge 956. The tabs 962 may engage respective projections (not shown) on the latch 904 to couple the bridge 956 with the latch 904. The tabs 962 may alternatively engage with an opening or a hole provided in a latch housing 912 of the latch 904.

The bridge 956 has a second bridge portion 960 which is detachably attached to the second portion 908 of the catch 902. The second bridge portion 960 may be shaped such as to conform to the shape of the second portion 908 of the catch 902. The second bridge portion 960 of the bridge 956 may include projections which may get snap-fitted into slots provided on the catch 902. The second bridge portion 960 may also be attached to the second portion 908 of the catch 902 through any other suitable removable coupling methods, such as snap-fit, hook and loop fastener, etc.

With reference to FIG. 10, the latch 904 has a pivot axis 942 about which the locking arm 914 is pivoted. The latch housing 912 may include a cutout or an opening through which the locking arm 914 extends outwards from the latch housing 912. The latch housing 912 may include other structural features such as holes or openings (not shown). The first bridge portion 958 of the bridge 956 may have protrusions which may be received by the holes or openings to couple the bridge 956 with the latch housing 912.

The bridge 956 further includes a rib 966 extending downwards from the first bridge portion 958. The rib 966 may have a generally rectangular cross-section. The rib 966 is adapted to engage with the locking arm 914 upon coupling of the bridge 956 with the latch 904. When the bridge 956 is engaged with the latch 904, the rib 966 moves the locking arm 914 to the disengaged position in which the projection 916 is disengaged from the second portion 908 of the catch 902. Thus, the locking device 900 is advantageously in the disengaged position during installation. This eliminates the need for an unlocking component, such as a magnetic key, to move the locking arm 914 to the disengaged position during installation. However, in case the bridge 956 is not being used during installation, the magnetic key may be used.

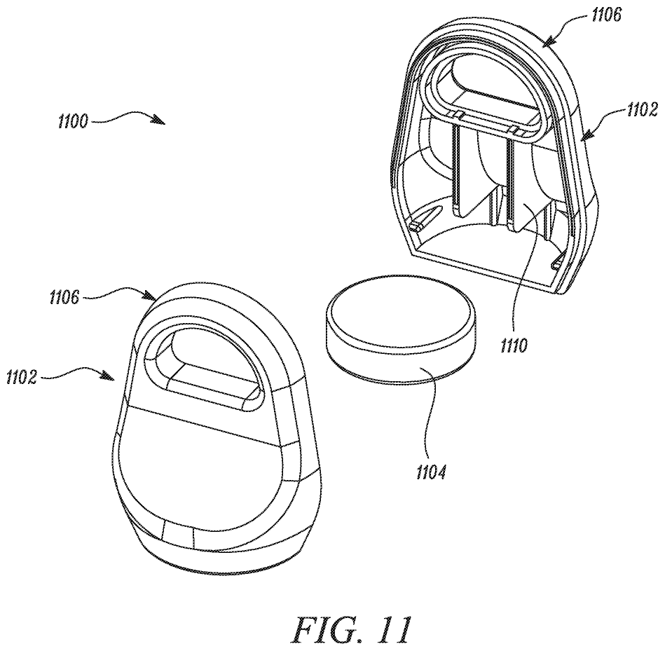

FIG. 11 shows an exemplary magnetic key 1100. The magnetic key 1100 includes a key housing 1102. The key housing 1102 has a substantially hollow structure. The key housing 1102 accommodates a key magnet 1104 therein. The key magnet 1104 is illustrated as a disc shaped magnet which may have opposing surfaces of opposite magnetic polarities. The key housing 1102 further includes a grip portion 1106 in the key housing 1102. A user may hold the magnetic key 1100 by gripping the grip portion 1106. The key housing 1102 is shown has having two parts. Both the parts include complementary internal structural features 1110 for coupling both the parts with each other. The user may suitably place the magnetic key 1100 on the movable component 936 and open/gain access to the enclosure 932. With combined reference to FIGS. 5 and 11, the user may place the magnetic key 1100 on an outer surface of the latch housing 112 towards the front side 122 of the latch housing 112. The key magnet 1104 may attract the first magnet 120 towards the magnetic key 1100. Movement of the first magnet 120 also brings the locking arm 114 towards the front side 122 of the latch housing 112, which in turn disengages the projection 116 of the locking arm 114 from the catch 102.

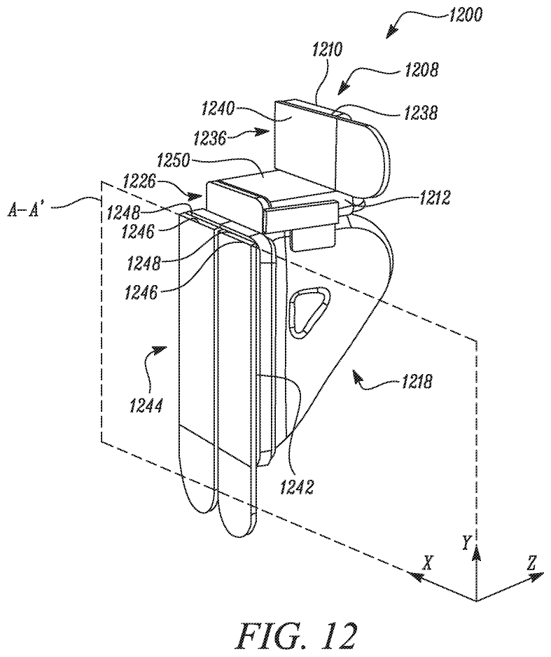

FIG. 12 depicts another exemplary configuration of a locking device 1200 for an enclosure (not shown). The enclosure has a frame and a movable component. The locking device 1200, as shown in FIG. 12, may be envisioned as a ready to install configuration of the locking device 1200. The locking device 1200 includes a catch 1208. The catch 1208 has a first portion 1210 and a second portion 1212. The first portion 1210 of the catch 1208 has a catch adhesive construction 1236 attached to the first portion 1210. The catch adhesive construction 1236 has a first adhesive surface 1238 and a second adhesive surface 1240. The first adhesive surface 1238 of the catch adhesive construction 1236 is coupled to the first portion 1210 of the catch 1208. The second adhesive surface 1240 of the catch adhesive construction 1236 is adapted to be engaged with a surface of the frame for coupling the catch 1208 with the surface of the frame. It should be contemplated that the catch adhesive construction 1236 may be alternatively or additionally applied to the second portion 1212 of the catch 1208.

The locking device 1200 further includes a latch 1218. The latch 1218 has a coupling surface 1242 which is disposed towards the movable component when the latch 1218 is installed on the movable component. The locking device 1200 includes at least one latch adhesive construction 1244 adapted to attach the latch 1218 to the movable component. In the illustrated example, the at least one latch adhesive construction 1244 includes two latch adhesive constructions 1244. The latch adhesive construction 1244 has a first adhesive surface 1246 and a second adhesive surface 1248. Hereinafter, the first adhesive surface 1246 and the second adhesive surface 1248 are referred to as a first surface 1246 and a second surface 1248 respectively for clarity purposes. The first surface 1246 is attached to the coupling surface 1242. The second surface 1248 is adapted to be attached with the movable component for coupling the latch 1218 with the movable component.

The locking device 1200 further includes a bridge 1226 adapted to be removably coupled to both the catch 1208 and the latch 1218. The bridge 1226 may have any suitable shape such that the bridge 1226 conforms to shapes of both the catch 1208 and the latch 1218. The bridge 1226 allows easy installation of the locking device 1200. The bridge 1226 is coupled to the catch 1208 and the latch 1218 during attachment of the catch 1208 to the frame and attachment of the latch 1218 to the movable component. The bridge 1226 is removed from the catch 1208 and the latch 1218 after attachment of the catch 1208 to the frame and attachment of the latch 1218 to the movable component. The bridge 1226 acts as an intermediate component to temporarily hold the catch 1208 and the latch 1218 together during installation of the locking device 1200.

As depicted through FIG. 12, the at least one latch adhesive construction 1244 extends generally in a plane A-A′ perpendicular to a first major surface 1250 of the second portion 1212 of the catch 1208. The plane A-A′ is along X-Y plane, while the first major surface 1250 is along X-Z plane. The first adhesive surface 1238 and the second adhesive surface 1240 extend parallel to each other as well as parallel to the plane A-A′. Further, the first surface 1246 and the second surface 1248 extend along the plane A-A′. In another exemplary embodiment, the at least one latch adhesive construction 1244 may extend generally in a plane perpendicular to both a plane defined by the first portion 1210 and a plane defined by the second portion 1212 of the catch 1208. In such an embodiment, the second surface 1248 extends perpendicular to the plane defined by the first portion 1210 and the plane defined by the second portion 1212.

In some embodiments, the locking device 1200 is actuated magnetically. A locking arm (not shown) is adapted to be actuated magnetically from an engaged position to a disengaged position through a magnetic key (not shown). The locking arm is adapted to be magnetically actuated to a disengaged position in which the projection is disengaged from the second portion 1212 of the catch 1208. The magnetic key may be touched with an outer surface of the movable component such that the locking arm is actuated to the disengaged position and the locking device 1200 allows opening of the enclosure.

Both the catch adhesive construction 1236 and the latch adhesive construction 1244 may initially have both the first and second adhesive surfaces 1238, 1240 and the first and second surfaces 1246, 1248, covered by peelable covers or liners (not shown). When the catch adhesive construction 1236 and the latch adhesive construction 1244 are to be installed, the peelable liners are removed and applied to the respective components. The second adhesive surface 1240 and the second surface 1248 are exposed when the respective components are to be attached to the respective locations on the enclosure. This will be further explained in detail in the forthcoming description.

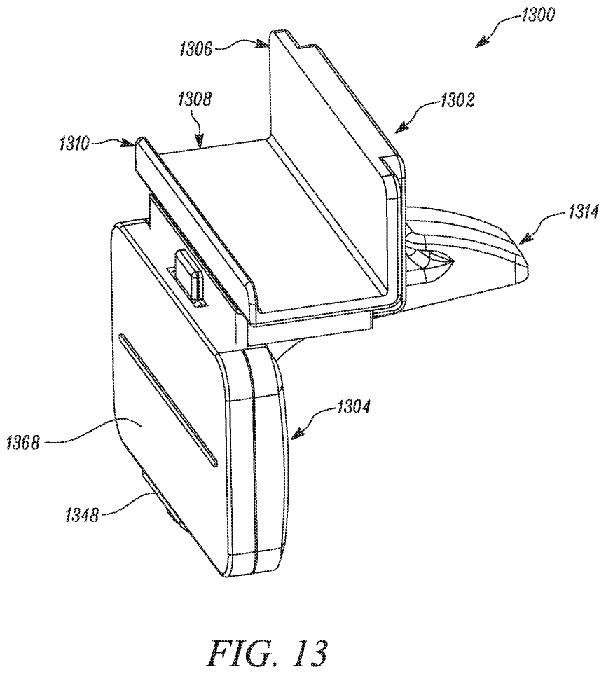

FIG. 13 shows another embodiment of the present disclosure illustrating a locking device 1300. The locking device 1300 is a spring type locking device. The locking device 1300 includes a catch 1302. The catch 1302 includes a first portion 1306 and a second portion 1308. The catch 1302 further includes a lip 1310 extending from the second portion 1308. The lip 1310 extends generally perpendicular to the second portion 1308. The lip 1310 may enable improved retention of the catch 1302 on a frame of an enclosure (not shown) with which the locking device 1300 is attached. The lip 1310 may prevent axial motion of the catch 1302 relative to the frame of the enclosure.

The locking device 1300 further includes a latch 1304. The latch 1304 has a coupling surface 1368 which is disposed towards the movable component when the latch 1304 is installed on the movable component.

The locking device 1300 can be actuated by manually pushing down on a locking arm 1314. The locking device 1300 includes a slidable switch 1348 for disabling the locking device 1300.

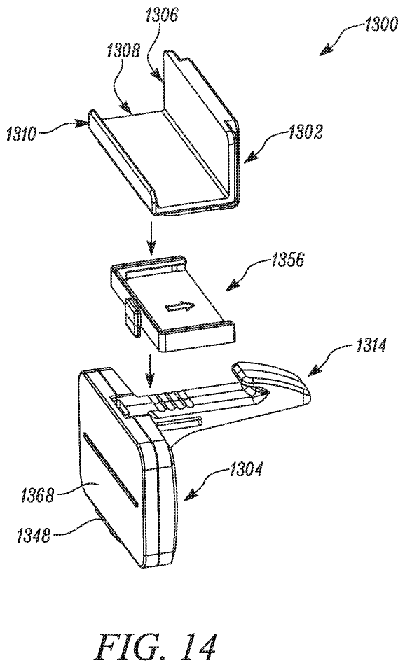

FIG. 14 shows an exploded view of the locking device 1300. The locking device 1300 further includes a bridge 1356 adapted to be removably coupled to both the catch 1302 and the latch 1304. The bridge 1356 may have any suitable shape such that the bridge 1356 conforms to shapes of both the catch 1302 and the latch 1304. The bridge 1356 allows easy installation of the locking device 1300. The bridge 1356 is coupled to the catch 1302 and the latch 1304 during attachment of the catch 1302 to the frame and attachment of the latch 1304 to the movable component. The bridge 1356 is removed from the catch 1302 and the latch 1304 after attachment of the catch 1302 to the frame and attachment of the latch 1304 to the movable component. The bridge 1356 acts as an intermediate component to temporarily hold the catch 1302 and the latch 1304 together during installation of the locking device 1300.

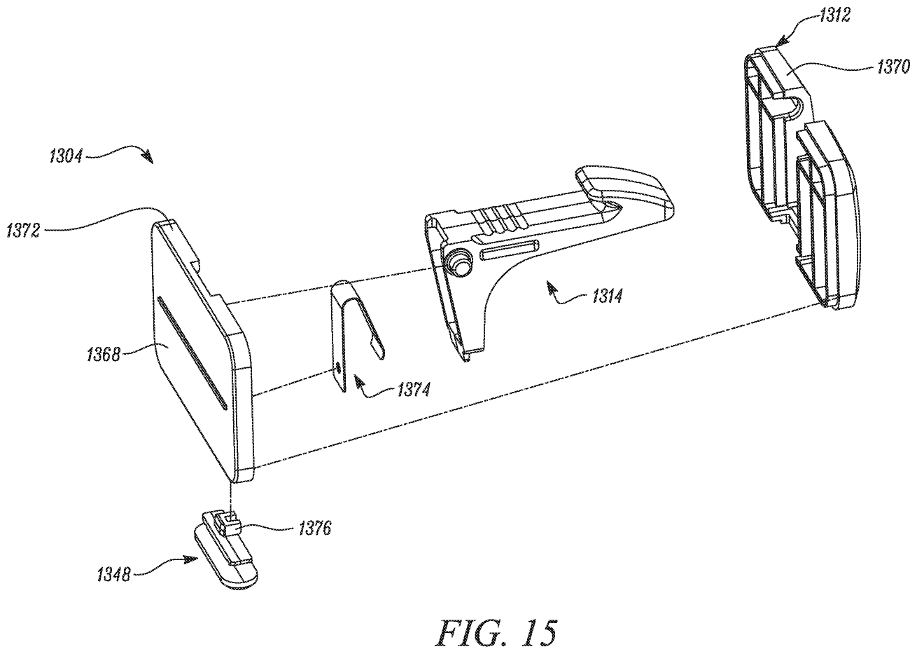

FIG. 15 shows an exploded view of the latch 1304. The latch 1304 includes a latch housing 1312. The latch housing 1312 is shown as a two-part structure. The latch housing 1312 includes a first cover portion 1370 and a second cover portion 1372. The first and second cover portions 1370, 1372 together at least partially enclose the locking arm 1314. The latch housing 1312 further encloses a spring 1374. The spring 1374 is adapted to bias the locking arm 1314 to an engaged position of the locking arm 1314 with the catch 1302. In the illustrated embodiment, the bridge 1356 keeps the locking arm 1314 in the disengaged position.

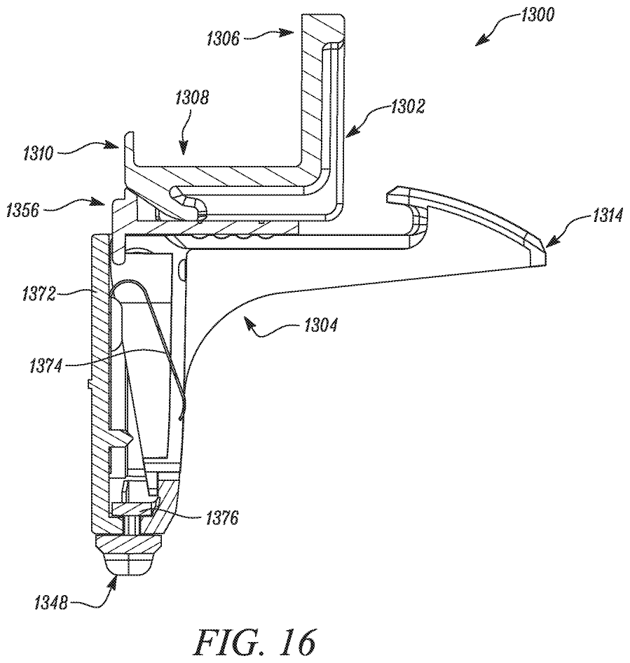

The latch 1304 further includes the slidable switch 1348. The slidable switch 1348 has an engagement element 1376. FIG. 16 shows a sectional view of the locking device 1300. The spring 1374 is disposed between the latch housing 1312 and the locking arm 1314. With combined reference to FIGS. 15 and 16, the slidable switch 1348 may slide between a first position and a second position. The first position may be referred to as an engaged position and the second position may be referred to as a disengaged position. In the engaged position, the slidable switch 1348 biases the spring 1374 towards the locking arm 1314 through the engagement element 1376. This causes the locking arm 1314 to be engaged with the catch 1302. When the slidable switch 1348 slides to the disengaged position, the engagement element 1376 does not contact the spring 1374 or the locking arm 1314, and the locking arm 1314 can be moved out of contact with the catch 1302. In the illustrated figure, although the slidable switch 1348 is in engaged position, the locking arm 1314 is not engaged with the catch 1302 due to the bridge 1356 coupled between the catch 1302 and the latch 1304.

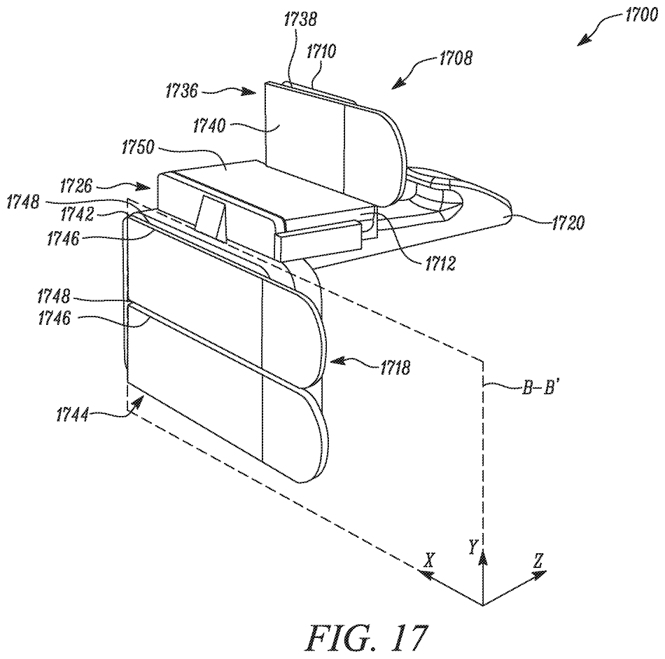

FIG. 17 depicts another exemplary configuration of a locking device 1700 for an enclosure (not shown). The enclosure has a frame and a movable component. The locking device 1700, as shown in FIG. 17, may be envisioned as a ready to install configuration of the locking device 1700. The locking device 1700 includes a catch 1708. The catch 1708 includes a first portion 1710 and a second portion 1712. The first portion 1710 of the catch 1708 has a catch adhesive construction 1736 attached to the first portion 1710. The catch adhesive construction 1736 has a first adhesive surface 1738 and a second adhesive surface 1740. The first adhesive surface 1738 of the catch adhesive construction 1736 is coupled to the first portion 1710 of the catch 1708. The second adhesive surface 1740 of the catch adhesive construction 1736 is adapted to be engaged with a surface of the frame for coupling the catch 1708 with the surface of the frame. It should be contemplated that the catch adhesive construction 1736 may alternatively or additionally be applied to the second portion 1712 of the catch 1708.

The locking device 1700 further includes a latch 1718. The latch 1718 has a coupling surface 1742 which is disposed towards the movable component when the latch 1718 is installed on the movable component. The locking device 1700 includes at least one latch adhesive construction 1744 adapted to attach the latch 1718 to the movable component. In the illustrated example, the at least one latch adhesive construction 1744 includes two latch adhesive constructions 1744. The latch adhesive construction 1744 has a first adhesive surface 1746 and a second adhesive surface 1748. Hereinafter, the first adhesive surface 1746 and a second adhesive surface 1748 are referred to as a first surface 1746 and a second surface 1748 respectively for clarity purposes. The first surface 1746 is attached to the coupling surface 1742. The second surface 1748 is adapted to be attached with the movable component for coupling the latch 1718 with the movable component.

The locking device 1700 further includes a bridge 1726 adapted to be removably coupled to both the catch 1708 and the latch 1718. The bridge 1726 may have any suitable shape such that the bridge 1726 conforms to shapes of both the catch 1708 and the latch 1718. The bridge 1726 allows easy installation of the locking device 1700. The bridge 1726 is coupled to the catch 1708 and the latch 1718 during attachment of the catch 1708 to the frame and attachment of the latch 1718 to the movable component. The bridge 1726 is removed from the catch 1708 and the latch 1718 after attachment of the catch 1708 to the frame and attachment of the latch 1718 to the movable component. The bridge 1726 acts as an intermediate component to hold the catch 1708 and the latch 1718 together during installation of the locking device 1700.

The locking device 1700 is spring actuated. More specifically, a biasing member (not shown), such as a spring, is adapted to keep a locking arm 1720 in an engaged position. The locking arm 1720 extends substantially perpendicular to the latch 1718. As depicted in FIG. 17, the at least one latch adhesive construction 1744 extends generally in a plane B-B′ parallel to a first major surface 1750 of the second portion 1712 of the catch 1708. The plane B-B′ is parallel to the X-Y plane, while the first major surface 1750 is parallel to the X-Z plane. The first adhesive surface 1738 and the second adhesive surface 1740 extend parallel to each other as well as parallel to the plane B-B′. Further, the first surface 1746 and the second surface 1748 extend parallel to the plane B-B′.

FIG. 18A-F show steps of preparation of a locking device 1800 for installation. FIGS. 18A-F visually show steps of installation of a locking device 1800 with a bridge 1826. Referring to FIG. 18A, a first peelable cover or liner 1860, if supplied, is peeled off from a first adhesive surface 1838 of a catch adhesive construction 1836. The first adhesive surface 1838 is then applied to a second portion 1812 of a catch 1808. It should be contemplated that the first adhesive surface 1838 may alternatively or additionally be applied to a first portion 1810 of the catch 1808. Afterwards, a second peelable liner 1862 is removed from a first surface 1846 of a latch adhesive construction 1844. The first surface 1846 of the latch adhesive construction 1844 is applied to a coupling surface 1842 of a latch 1818.

Referring to FIG. 18B, the catch 1808 is slid on to the bridge 1826 by a user, and removably coupled to the bridge 1826 through a snap-fit connection. The bridge 1826 may include channels to slidably receive ends of second portion 1812 of the catch 1808. The ends of second portion 1812 may smoothly slide into the channels and allow the coupling between the catch 1808 and the bridge 1826. The bridge 1826 is now coupled with the catch 1808. Referring to FIG. 18C, the locking device 1800 is now ready for installation. The bridge 1826 is coupled to the latch 1818. More specifically, the bridge 1826 along with the catch 1808 is coupled to a latch housing 1819 through snap-fit coupling, or any other suitable mechanical coupling methods.

As shown in FIG. 18D, the catch 1808 is aligned to a bottom of the frame 1804 and pulled towards the frame 1804 by the user to apply the catch adhesive construction 1836. The catch 1808 is pressed on by the user firmly for a predetermined time. In one example, the pre-determined time is about 30 seconds. Now referring to FIG. 18E, the movable component 1806 is pressed firmly against the latch 1818. The movable component 1806 may be pressed firmly for a predetermined time. In one example, the pre-determined time is about 10 seconds.

As the latch adhesive construction 1844 is already applied, the movable component 1806 is attached to the latch 1818. Now, the movable component 1806 may be pulled away slowly by the user. When the bridge 1826 is coupled with the catch 1808 and the latch 1818, the locking device 1800 is in the disengaged position. The bridge 1826 will remain coupled with the latch 1818 and gets uncoupled from the catch 1808 when the moveable component 1808 moves away from the frame 1804. The latch 1818 is now installed with the movable component 1806. Referring to FIG. 18F, the bridge 1826 is removed slowly by the user. The latch 1818 is pressed on the movable component 1806 firmly once again. The movable component 1806 is now pushed towards the frame 1804 to close the enclosure 1802. The latch 1818 now engages with the catch 1808 and locks the enclosure 1802. Removing the bridge 1826 releases the locking arm, placing the latch 1826 in an engaged position.

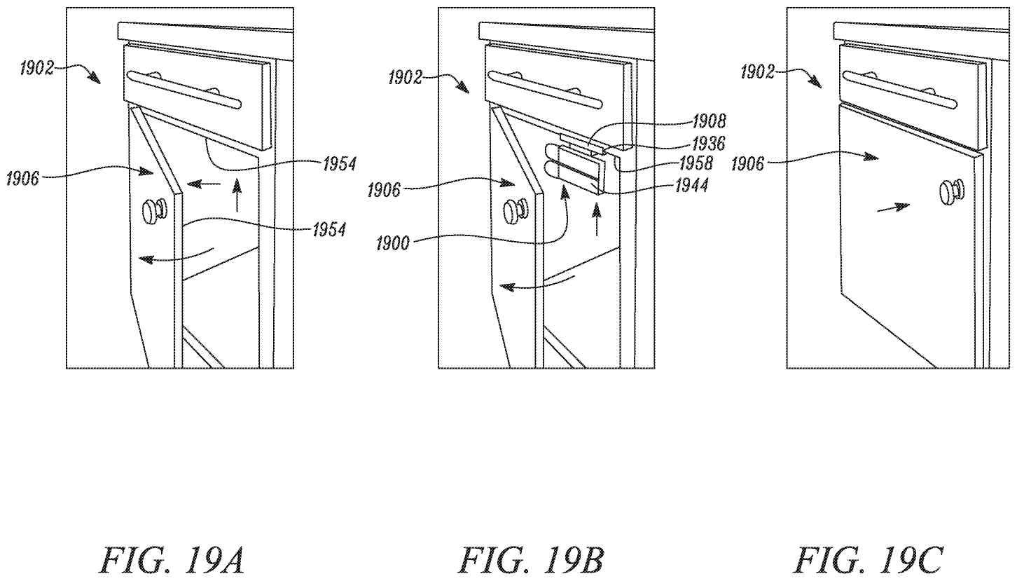

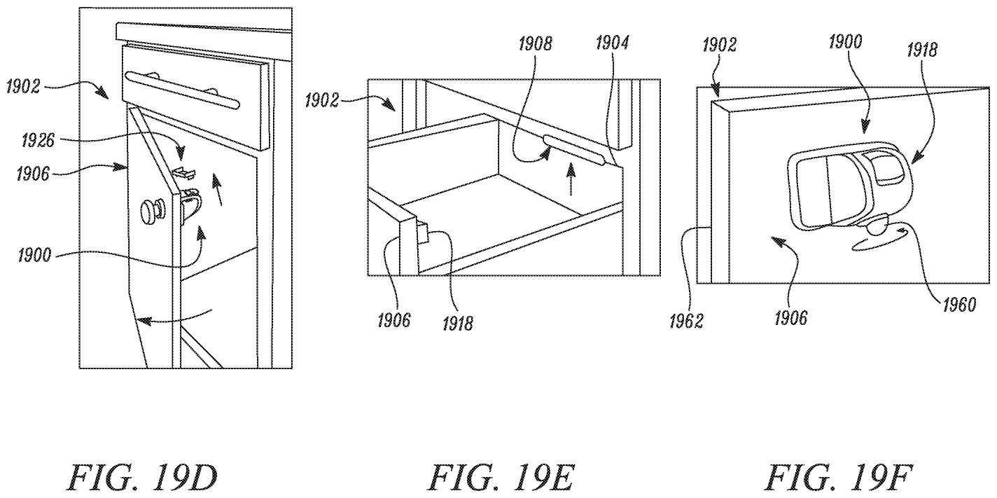

FIGS. 19A-F visually show steps of installation of a locking device 1900 with a bridge 1926. The locking device 1900 is a magnetic locking device for a door 1906 of a cabinet 1902. The locking device 1900 includes a latch 1918, a latch adhesive construction 1944, a catch 1908, a catch adhesive construction 1936, the bridge 1926, and a magnetic key (not shown). At first, a first peelable liner, if supplied, is peeled off from a first adhesive surface of the catch adhesive construction 1936. The first adhesive surface is then applied to a first portion of the catch 1908. It should be contemplated that the first adhesive surface may alternatively be applied to a second portion of the catch 1908. Afterwards, a peelable liner is removed from a first surface of the latch adhesive construction 1944. The first surface of the latch adhesive construction 1944 is applied to a coupling surface of the latch 1918. Further, the catch 1908 is slid on to the bridge 1926 by a user, and removably coupled to the bridge 1926 through a snap-fit connection. The bridge 1926 is now coupled with the catch 1908. The locking device 1900 is now ready for installation.

Referring to FIG. 19A, the door 1906 is opened. The locking device 1900 is installed in an upper corner 1954 opposite to a hinge side 1956 of the door 1906. For preparation, inside surfaces 1954 of the cabinet 1902 and the door 1906 can be wiped by any suitable cleaning liquid, such as rubbing alcohol. Referring to FIG. 19B, the locking device 1900 is shown with all the peelable liners, if supplied, removed from the catch adhesive construction 1936 and the latch adhesive construction 1944. Now, the catch 1908 is applied to the upper corner 1958 of the door 1906 and pressed firmly for a predetermined amount of time, for example, about 10 seconds. Referring to FIG. 19C, the door 1906 is closed, and pressed lightly for a predetermined amount of time, for example, about 10 seconds.

Now referring to FIG. 19D, the door 1906 is opened slowly, and the bridge 1926 is removed. As the bridge 1926 keeps the locking device 1900 in the disengaged state, the door 1906 is opened easily. The bridge 1926 may be stored for future installations. Referring to FIG. 19E, the catch 1908 and the latch 1918 are pressed firmly against a frame 1904 of the cabinet 1902 and the door 1906 of the cabinet 1902, respectively.

Referring to FIG. 19F, the user locates a switch 1960 under the latch 1918 and rotates the switch 1960 in an unlocking direction to disable the locking device 1900. The unlocking direction may be clockwise direction or counter-clockwise direction. The locking device 1900 can be optionally kept in a disabled state for a predetermined amount of time to allow the locking device 1900 to adhere adequately with the corresponding surfaces. The predetermined amount of time may be, for example, about 24 hours. After passage of the predetermined amount of time, the switch 1960 may be rotated back to an initial position and enable the locking device 1900.

For opening the door 1906 of the cabinet 1902, the magnetic key is placed on an outer surface 1962 of the door 1906 opposite to where the locking device 1900 is installed. The user moves the magnetic key around this region until the user hears a click sound or other auditory indication. This sound indicates disengagement of a locking arm with the catch 1908. Now, the user keeps placing the magnetic key on the door 1906 and opens the door 1906 slowly. Further, for removal of the locking device 1900, the latch adhesive construction 1944 and the catch adhesive construction 1936 are pulled sideways to peel off cleanly from the corresponding surfaces.

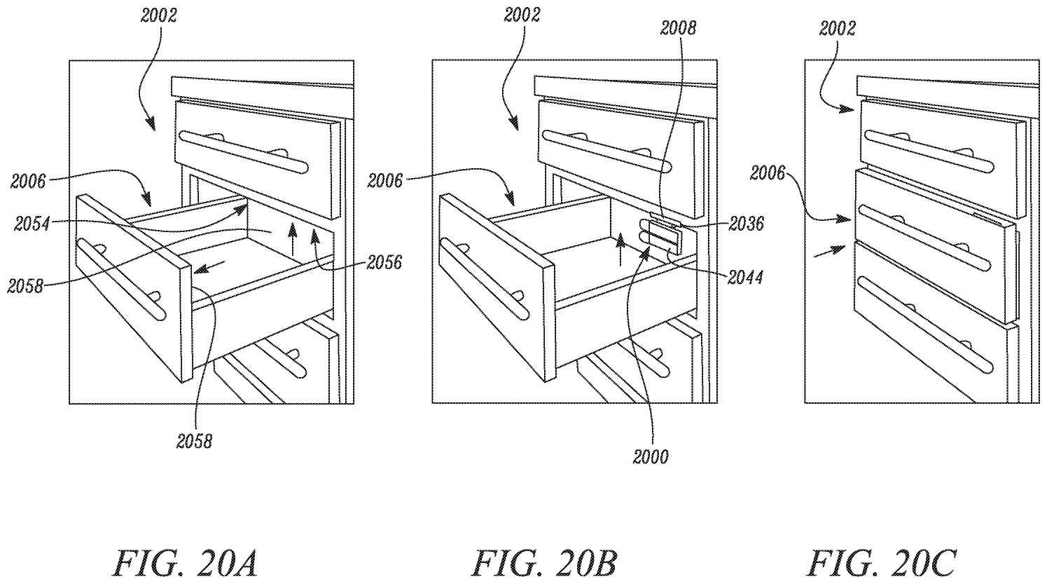

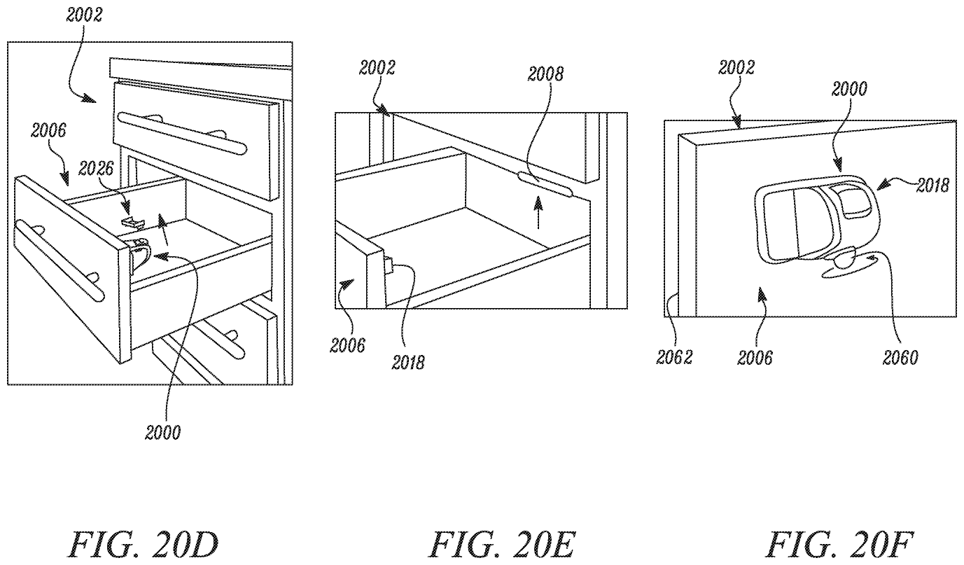

FIGS. 20A-F visually show steps of installation of a locking device 2000 with a bridge 2026.

The locking device 2000 is a magnetic locking device for a drawer 2006 of a cabinet 2002. The locking device 2000 includes a latch 2018, a latch adhesive construction 2044, a catch 2008, a catch adhesive construction 2036, the bridge 2026, and a magnetic key (not shown). At first, a peelable liner, if supplied, is peeled off from a first adhesive surface of the catch adhesive construction 2036. The first adhesive surface is then applied to a first portion of the catch 2008. It should be contemplated that the first adhesive surface may alternatively be applied to a second portion of the catch 2008. Afterwards, a peelable liner, if supplied, is removed from a first surface 2046 of a latch adhesive construction 2044. The first surface 2046 of the latch adhesive construction 2044 is applied to a coupling surface of the latch 2018. Further, the catch 2008 is slid on to the bridge 2026 by a user, and removably coupled to the bridge 2026 through a snap-fit connection. The bridge 2026 is now coupled with the catch 2008. The locking device 2000 is now ready for installation.

Referring to FIG. 20A, the drawer 2006 is opened. The locking device 2000 is to be installed in an upper left corner 2054 or an upper right corner 2056 of the drawer 2006. For preparation, inside surfaces 2058 of the cabinet 2002 and the drawer 2006 are wiped by any suitable cleaning liquid, such as rubbing alcohol. Referring to FIG. 20B, the locking device 2000 is shown with all the peelable liners removed from the catch adhesive construction 2036 and the latch adhesive construction 2044. Now, the catch 2008 is applied to the upper right corner 2056 of the drawer 2006 and pressed firmly for a predetermined amount of time, for example, about 10 seconds. It should be understood that the catch 2008 may alternatively be applied to the upper left corner 2054 as well. Referring to FIG. 20C, the drawer 2006 is closed, and pressed lightly for a predetermined amount of time, for example, about 10 seconds.

Now referring to FIG. 20D, the drawer 2006 is opened slowly, and the bridge 2026 is removed. As the bridge 2026 keeps the locking device 2000 in a disengaged state, the drawer 2006 is opened easily. The bridge 2026 may be stored for future installations. Referring to FIG. 20E, the catch 2008 and the latch 2018 are pressed firmly against the drawer 2006 of the cabinet 2002.

Referring to FIG. 20F, the user locates a switch 2060 under the latch 2018 and rotates the switch 2060 in an unlocking direction to disable the locking device 2000. The rotational direction may be clockwise direction or counter-clockwise direction. The locking device 2000 can be optionally kept in a disabled state for a predetermined amount of time to allow the locking device 2000 to adhere adequately with the corresponding surfaces. The predetermined amount of time may be, for example, about 24 hours. After passage of the predetermined amount of time, the switch 2060 may be rotated back to an initial position to enable the locking device 2000.

For opening the drawer 2006 of the cabinet 2002, the magnetic key is placed on an outer surface 2062 of the drawer 2006 opposite to where the locking device 2000 is installed. The user moves the magnetic key around this region until the user hears a click sound or another auditory indicator. This sound indicates disengagement of a locking arm with the catch 2008. Now, the user keeps placing the magnetic key on the drawer 2006 and opens the drawer 2006 slowly. Further, for removal of the locking device 2000, the latch adhesive construction 2044 and the catch adhesive construction 2036 are pulled sideways to peel off cleanly from the corresponding surfaces.

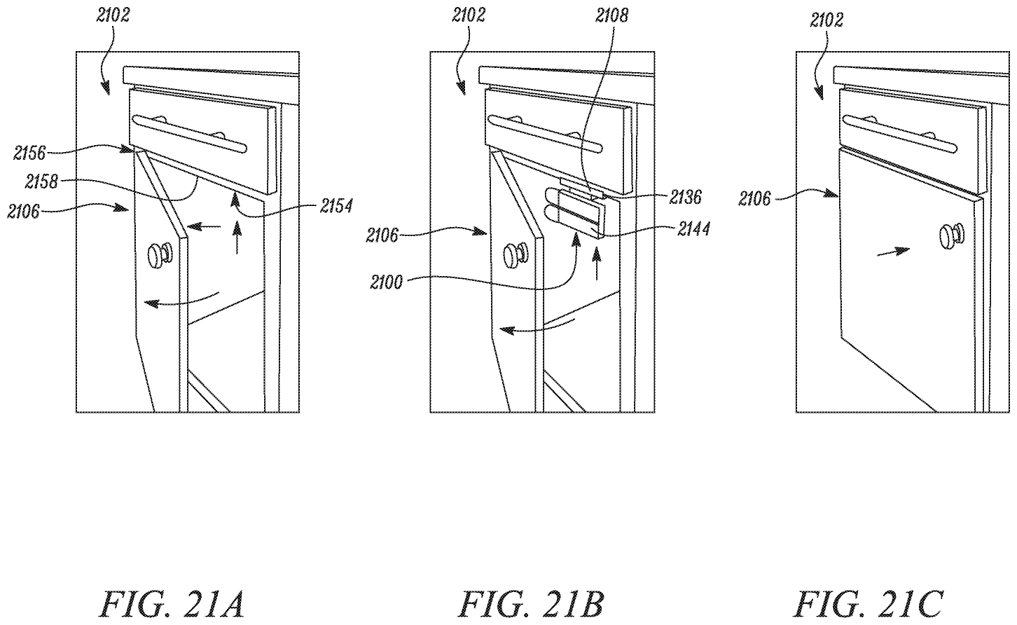

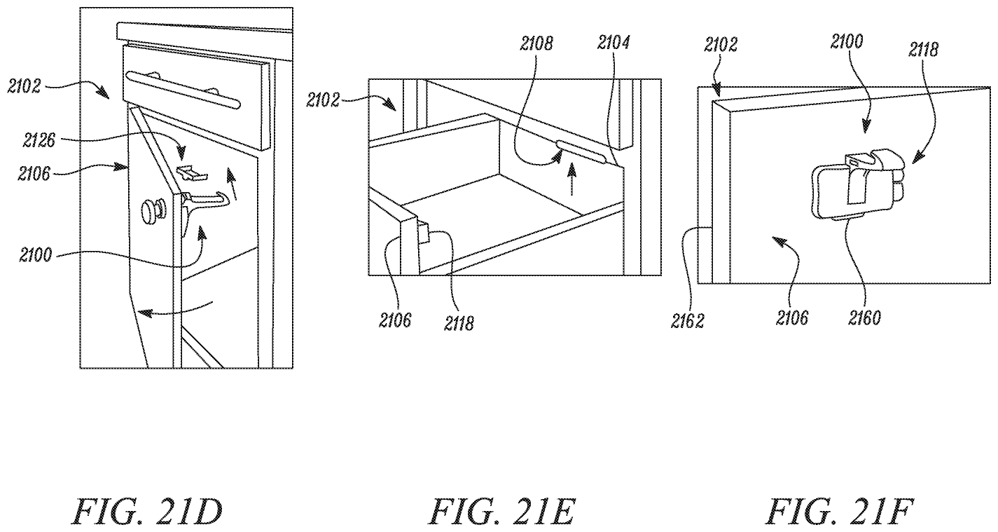

FIGS. 21A-F visually show steps of installation of a locking device 2100 with a bridge 2126. The locking device 2100 is a spring-type locking device for a door 2106 of a cabinet 2102. The locking device 2100 includes a latch 2118, a latch adhesive construction 2144, a catch 2108, a catch adhesive construction 2136, the bridge 2126, and a magnetic key (not shown). At first, a peelable liner is peeled off from a first adhesive surface of the catch adhesive construction 2136. The first adhesive surface is then applied to a first portion of the catch 2108. It should be contemplated that the first adhesive surface may alternatively be applied to a second portion of the catch 2108. Afterwards, a peelable liner is removed from a first surface 2146 of a latch adhesive construction 2144. The first surface 2146 of the latch adhesive construction 2144 is applied to a coupling surface of the latch 2118. Further, the catch 2108 is slid on to the bridge 2126 by a user, and removably coupled to the bridge 2126 through a snap-fit connection. The bridge 2126 is now coupled with the catch 2108. The locking device 2100 is now ready for installation.

Referring to FIG. 21A, the door 2106 is opened. The locking device 2100 is to be installed in an upper corner 2154 opposite to a hinge side 2156 of the door. For preparation, inside surfaces 2158 of the cabinet 2102 and the door 2106 are wiped by any suitable cleaning liquid, such as rubbing alcohol. Referring to FIG. 21B, the locking device 2100 is shown with all the peelable liners removed from the catch adhesive construction 2136 and the latch adhesive construction 2144. Now, the catch 2108 is applied to the upper corner 2154 of the door 2106 and pressed firmly for a predetermined amount of time, for example, about 10 seconds. Referring to FIG. 21C, the door 2106 is closed, and pressed lightly for a predetermined amount of time, for example, about 10 seconds.

Now referring to FIG. 21D, the door 2106 is opened slowly and the latch 2118 is pressed down to release the door 2106. Referring to FIG. 21E, the door 2106 is opened, and the bridge 2126 is removed. As the bridge 2126 keeps the locking device 2100 in a disengaged state, the door 2106 is opened easily. The bridge 2126 may be stored for future installations. Referring to FIG. 21E, the catch 2108 and the latch 2118 are pressed firmly against the frame 2104 of the cabinet 2102 and the door 2106 of the cabinet 2102, respectively.

For opening the door 2106 of the cabinet 2102, the door 2106 is opened slightly, and the latch 2118 is pressed down by the user to open the door 2106. Further, for removal of the locking device 2100, the latch adhesive construction 2144 and the catch adhesive construction 2136 are pulled sideways to peel off cleanly from the corresponding surfaces.

The present disclosure further includes a method of installing a locking device on an enclosure having a frame and a movable component. The method includes attaching a catch of the locking device to the frame. The catch is attached to the frame such that a first portion of the catch is disposed adjacent to an inner surface of the frame and a second portion of the catch is disposed adjacent to an end of the frame. The second portion extends from the first portion and is generally perpendicular to the first portion. Such an exemplary structural arrangement can be seen in FIGS. 1-10. The locking device 100 includes the catch 102 attached to the frame 134. The catch 102 has the first portion 106 and the second portion 108. The first portion 106 is provided adjacent to the surface 138 of the frame 134. The second portion 108 is provided adjacent to the end 140 of the frame 134. The second portion 108 extends from the first portion 106. Further, the second portion 108 is generally perpendicular to the first portion 106.

The method includes removing a first liner from a catch adhesive construction to expose a first adhesive surface. For example, the first liner 1860 is removed from the catch adhesive construction 1836 to expose the first adhesive surface 1838. Attaching the catch to the frame includes applying the first adhesive surface of the catch adhesive construction to the first portion or the second portion of the catch based on structural configuration of the catch. The method also includes removing a second liner from the catch adhesive construction to expose a second adhesive surface. Further, the method includes applying the second adhesive surface of the catch adhesive construction to the frame.

The method includes attaching the latch of the locking device to the movable component. The latch includes a locking arm having a projection which engages with the second portion of the catch upon movement of the movable component away from the first portion of the catch. The projection may also engage with the second portion of the catch upon movement of the movable component away from the frame. Such an exemplary structural arrangement can be seen in FIGS. 1-10. The locking device 100 includes the latch 104 attached to the movable component 136. The latch 104 has the locking arm 114 for locking the latch 104 with the catch 102, and in turn locking the movable component 136 with the frame 134. The locking arm 114 has the projection 116. When the movable component 136 moves away from the frame 134, the projection 116 engages with the second portion 108 of the catch 102. More specifically, when the movable component 136 moves away from the second portion 108 of the catch 102, the projection 116 engages with the second portion 108 of the catch 102.

The method can include removing a first liner from at least one latch adhesive construction to expose a first adhesive surface. For example, the first liner 1862 is removed from the first adhesive surface 1846 as shown in FIG. 18A. Attaching the latch to the frame can includes applying the first adhesive surface of the latch adhesive construction to the latch. The method also includes removing a second liner from the latch adhesive construction to expose a second adhesive surface. Further, the method includes moving the movable component towards the frame such that the second adhesive surface of the at least one latch adhesive construction is applied to the movable component.

The method includes moving the locking arm to the disengaged position prior to moving the movable component away from the first portion of the catch. In the disengaged position, the projection is disengaged from the second portion of the catch. The method may include actuating a switch to retain the locking arm in the disengaged position for a predetermined amount of time. The switch may be a rotatable switch or a slidable switch. Instead of a switch, a magnetic key may also be used. The rotatable switch may be seen in FIGS. 1-10, and the slidable switch may be seen in FIGS. 13-15. The predetermined amount of time may be used to allow the catch adhesive construction and the latch adhesive construction to adhere adequately with the enclosure. In an exemplary situation, the predetermined time may be 12 hours, hours etc.

Removable coupling for the catch and the latch during installation is also provided. The method includes removably coupling a bridge to both the catch and the latch. The method includes moving the movable component away from the frame to disconnect the bridge from the catch after attachment of the catch to the frame and attachment of the latch to the movable component. The movable component may also be envisioned to be moved away from the second portion of the catch to disconnect the bridge from the catch after attachment of the catch to the frame and attachment of the latch to the movable component. The method further includes removing the bridge from the latch. The bridge may be used as a reusable component and may be stored for further usage. Structural features of the bridge 956 are explained with reference to FIGS. 9 and 10.

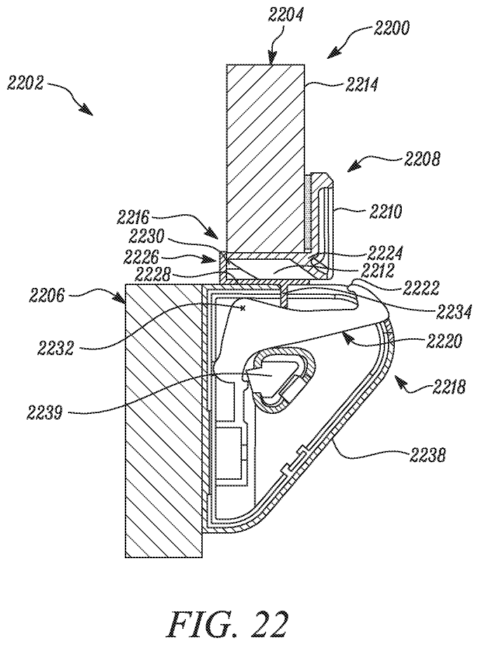

Referring to FIG. 22, another configuration for a locking device 2200 for an enclosure 2202 is provided. The locking device 2200 includes a catch 2208 attached to a frame 2204. The catch 2208 has a first portion 2210 and a second portion 2212. The first portion 2210 is provided adjacent to a surface 2214 of the frame 2204. The second portion 2212 is provided adjacent to an end 2216 of the frame 2204. The second portion 2212 extends from the first portion 2210. Further, the second portion 2212 is generally perpendicular to the first portion 2210.

The locking device 2200 includes a latch 2218 coupled to a movable component 2206. The latch 2218 has a locking arm 2220 for locking the latch 2218 with the catch 2208, and in turn locking the movable component 2206 with the frame 2204. The locking arm 2220 has a projection 2222. When the movable component 2206 moves away from the frame 2204, the projection 2222 engages with the second portion 2212 of the catch 2208. More specifically, when the movable component 2206 moves away from the second portion 2212 of the catch 2208, the projection 2222 engages with the second portion 2212 of the catch 2208. Further, the projection 2222 engages with a catch recess 2224 defined by the second portion 2212 of the catch 2208. In an example, the projection 2222 of the locking arm 2220 is a hook that is adapted to engage with the catch recess 2224.

The locking arm 2220 of the latch 2218 may move between an engaged position and a disengaged position. The locking device 2200 prevents the opening of the enclosure 2202 when the locking arm 2220 is in the engaged position. Further, the locking device 2200 allows opening of the enclosure 2202 when the locking arm 2220 is in the disengaged position relative to the catch 2208. The locking arm 2220 is depicted in the disengaged position in FIG. 22.

The locking device 2200 further includes a bridge 2226 adapted to be removably coupled to both the catch 2208 and the latch 2218. The bridge 2226 may have any suitable shape such that the bridge 2226 can be detachably attached to both the catch 2208 and the latch 2218. The bridge 2226 allows easier installation of the locking device 2200. The bridge 2226 is coupled to the catch 2208 and the latch 2218 during attachment of the catch 2208 to the frame 2204 and attachment of the latch 2218 to the movable component 2206. The bridge 2226 is removed from the catch 2208 and the latch 2218 after attachment of the catch 2208 to the frame 2208 and attachment of the latch 2218 to the movable component 2206. The bridge 2226 acts as an intermediate component to temporarily hold the catch 2208 and the latch 2218 together during installation of the locking device 2200. Specifically, the bridge 2226 enables alignment between the catch 2208 and the latch 2218 during installation. Such alignment may be required to ensure that the projection 2222 engages with the catch recess 2224 upon movement of the movable component 2206 away from the frame 2204, or the first portion 2210 of the catch 2208.

The bridge 2226 has a first bridge portion 2228 which is detachably attached to the latch 2218. The first bridge portion 2228 may be slidably attached to the latch 2218. The first bridge portion 2228 may also be attached to the latch 2218 through any other suitable detachable coupling methods, such as snap-fit, hook and loop fastener, etc. The first bridge portion 2228 may be shaped such as to conform to the shape of the latch 2218. The bridge 2226 has a second bridge portion 2230 which is detachably attached to the second portion 2212 of the catch 2208. The second bridge portion 2230 may be shaped so as to conform to the shape of the second portion 2212 of the catch 2208. The second bridge portion 2230 of the bridge 2226 may include projections which may get snap-fitted into slots provided on the catch 2208. The second bridge portion 2230 may also be attached to the second portion 2212 of the catch 2208 through any other suitable detachable coupling methods, such as hook and loop fastener.

With reference to FIG. 22, the latch 2218 has a pivot axis 2232 about which the locking arm 2220 is pivoted. The latch 2218 has a housing 2238. The housing 2238 may include a cutout or an opening through which the locking arm 2220 extends outwards from the housing 2238. A slide lock 2239 allows the locking arm 2220 to rotate away from the catch 2208 when engaged. A magnetic key may also be used to rotate the locking arm 2220 away from the catch 2208 to unlock the locking device 2200. The housing 2238 may include other structural features such as holes or openings (not shown). The first bridge portion 2228 of the bridge 2226 may have protrusions which may be received by the holes or openings to couple the bridge 2226 with the housing 2238 of the latch 2218.

The bridge 2226 further includes a rib 2234 extending downwards from the first bridge portion 2228. The rib 2234 may have a generally rectangular cross-section. The rib 2234 is adapted to engage with the locking arm 2220 upon coupling of the bridge 2226 with the latch 2218. When the bridge 2226 is engaged with the latch 2218, the rib 2234 moves the locking arm 2220 to the disengaged position in which the projection 2222 is disengaged from the second portion 2212 of the catch 2208. Thus, the locking device 2200 is advantageously in the disengaged position during installation. This eliminates the need for an unlocking component, such as the magnetic key, to move the locking arm 2220 to the disengaged position during installation.

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

1. A locking device for an enclosure having a frame and a movable component, the locking device comprising:
a catch attached to the frame, the catch comprising:
a first portion disposed adjacent to a surface of the frame; and
a second portion extending from and generally perpendicular to the first portion, wherein the second portion is disposed adjacent to an end of the frame; and
a latch attached to the movable component, the latch comprising a locking arm, the locking arm comprising a projection adapted to engage with the second portion of the catch upon movement of the movable component away from the first portion of the catch.

2. The locking device of claim 1, further comprising a bridge adapted to be removably coupled to both the catch and the latch, wherein the bridge is coupled to the catch and the latch during attachment of the catch to the frame and attachment of the latch to the movable component, and wherein the bridge is removed from the catch and the latch after attachment of the catch to the frame and attachment of the latch to the movable component.

3. The locking device of claim 2, wherein the bridge further comprises a rib that is adapted to engage with the locking arm upon coupling of the bridge with the latch, wherein, upon engagement, the rib moves the locking arm to a disengaged position in which the projection is disengaged from the second portion of the catch.

4. The locking device of claim 2, wherein the bridge is slidably coupled to the second portion of the catch.

5. The locking device of claim 2, wherein the bridge is coupled to the latch through a snap-fit connection.

6. The locking device of claim 1, further comprising a catch adhesive construction adapted to attach the catch to the frame, wherein the catch adhesive construction is at least one of disposed between the first portion of the catch and the frame, and disposed between the second portion of the catch and the frame.

7. The locking device of claim 1, wherein the second portion of the catch further comprises a catch recess that is adapted to releasably engage with the projection of the latch.

8. The locking device of claim 7, wherein the second portion of the catch further comprises a proximal end and a distal end, the proximal end being located adjacent to the first portion of the catch, wherein the catch recess terminates proximate the proximal end or the distal end.

9. The locking device of claim 7, wherein the second portion of the catch further comprises a proximal end and a distal end, the proximal end being located adjacent to the first portion of the catch, wherein the catch recess terminates generally midway between the proximal end and the distal end.

10. The locking device of claim 7, wherein the projection of the locking arm is a hook that is adapted to engage with the catch recess.

11. The locking device of claim 1, wherein the locking arm is adapted to be magnetically actuated to a disengaged position in which the projection is disengaged from the second portion of the catch.

12. The locking device of claim 11, wherein the locking arm is adapted to be pivoted to a disengaged position in which the projection is disengaged from the second portion of the catch.

13. The locking device of claim 1, wherein the latch further comprises a switch movable between a first position and a second position, and wherein, in the second position, the switch is adapted to retain the locking arm in a disengaged position in which the projection is disengaged from the second portion of the catch.

14. A method of installing a locking device on an enclosure having a frame and a movable component, the method comprising:
attaching a catch of the locking device to the frame such that a first portion of the catch is disposed adjacent to an inner surface of the frame and a second portion of the catch is disposed adjacent to an end of the frame, the second portion extending from and generally perpendicular to the first portion; and
attaching a latch of the locking device to the movable component, the latch comprising a locking arm having a projection adapted to engage with the second portion of the catch upon movement of the movable component away from the first portion of the catch.

15. The method of claim 14, further comprising removably coupling a bridge to both the catch and the latch.

16. The method of claim 14, further comprising moving the movable component away from the first portion of the catch to disconnect the bridge from the catch after attachment of the catch to the frame and attachment of the latch to the movable component.

17. The method of claim 14, further comprising moving the locking arm to a disengaged position prior to moving the movable component away from the first portion of the catch, wherein, in the disengaged position, the projection is disengaged from the second portion of the catch.

18. The method of claim 14, further comprising actuating a switch to retain the locking arm in a disengaged position wherein, in the disengaged position, the projection is disengaged from the second portion of the catch.

19. The method of claim 14, wherein attaching the catch to the frame further comprises:
applying a first adhesive surface of a catch adhesive construction to the first portion or the second portion of the catch; and
applying a second adhesive surface of the catch adhesive construction to the frame.

20. The method of claim 14, wherein attaching the latch to the frame further comprises:
applying a first adhesive surface of at least one latch adhesive construction to the latch; and
moving the movable component towards the frame such that a second adhesive surface of the at least one latch adhesive construction is applied to the movable component.
